(19) United States
(12) Patent Application Publication
(10) Pub. No.: US 2025/0357513 A1
(43) Pub. Date: Nov. 20, 2025

(54) METHOD FOR RESTORING PERFORMANCE

(71) Applicant: Liva Power Management Systems GmbH, Frankfurt am Main (DE)

(72) Inventors: Yifeng Li, Steinheim (DE); Thomas Lüth, Freiburg (DE); David Kienbaum, Freiburg (DE)

(21) Appl. No.: 18/871,095

(22) PCT Filed: Apr. 20, 2023
(86) PCT No.: PCT/EP2023/060296

§ 371 Date: Dec. 2, 2024

(30) Foreign Application Priority Data
Jun. 2, 2022 (DE) 10 2022 113 939.5

(51) Int. Cl. H01M 8/04746; H01M 8/04537; H01M 8/04664; H01M 8/18

(52) U.S. Cl. CPC H01M 8/04776; H01M 8/04567; H01M 8/04664; H01M 8/18

(57) ABSTRACT

The invention relates to a method for restoring the performance of a vanadium redox flow battery module in a battery system, the method comprising the following steps in the order indicated: identifying at least one degraded battery module; switching off the pumps of the at least one degraded battery module at a time t1; switching on the pumps of the at least one degraded battery module at a time t2; wherein the length of the time interval Δt=t2−t1 is selected such that, at the time t2, a terminal voltage of the degraded battery module is negative, but overcharging of the electrolyte located in the cell assembly of the degraded battery module is avoided, and wherein these steps, with the exception of the first step, take place while the battery system is being discharged.

The invention relates to a method for restoring the performance of a vanadium redox flow battery module in a battery system. Here, the battery system comprises several vanadium battery modules connected in series.

The performance of a vanadium-based redox flow battery module can slowly decrease over time during operation. One of the processes responsible for this is that oxidation processes take place at the positive electrode, so that a thin layer of oxygen-containing functional groups can form on this electrode over time. This increases the internal resistance of the battery module, which in turn leads to a lower efficiency thereof. This phenomenon is referred to in the following as “degradation” and an affected battery module as “degraded”.

Methods for restoring the performance of vanadium-based battery modules are known from the prior art. For example, CN 111 261 888 A discloses a method for recycling electrode material of such a battery module. Here, however, the cell assembly of the battery module in question must be deinstalled and completely disassembled. CN 111 509 278 A discloses a method for restoring the performance of a vanadium battery module that can be carried out while the battery module is in operation. To this end, the positive electrolyte is mixed with the negative electrolyte and additionally the battery module is reversed in polarity, i.e. the original positive terminal becomes the negative terminal and vice versa. To do this, the battery module must include means to enable mixing and polarity reversal. Such means are usually not provided in conventional battery modules.

It is the object of the invention to provide a method for restoring the performance of vanadium-based battery modules that is less expensive than the methods known from the prior art.

The object is achieved according to the invention by an embodiment according to the independent claim. Further advantageous embodiments of the present invention can be found in the sub-claims.

The invention is explained below with reference to the figures. The figures show in detail:

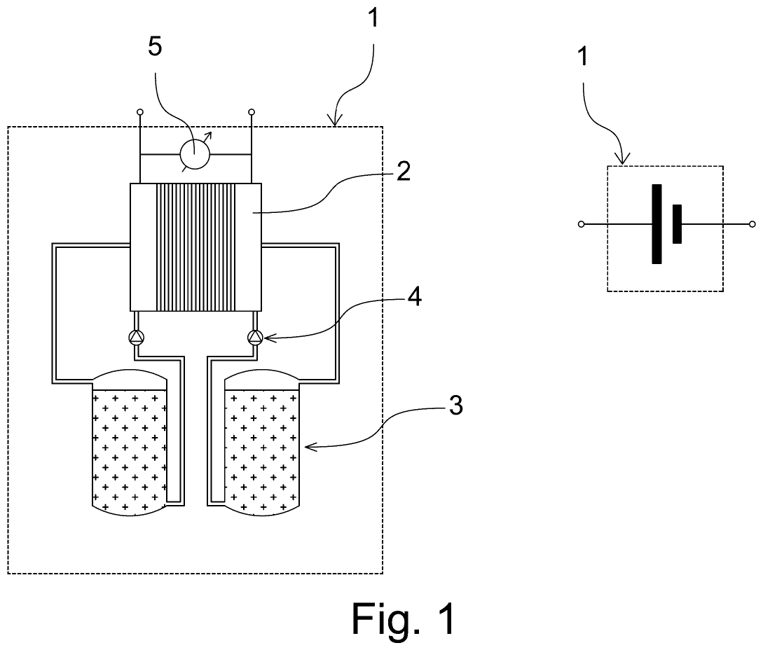

FIG. 1 a battery module;

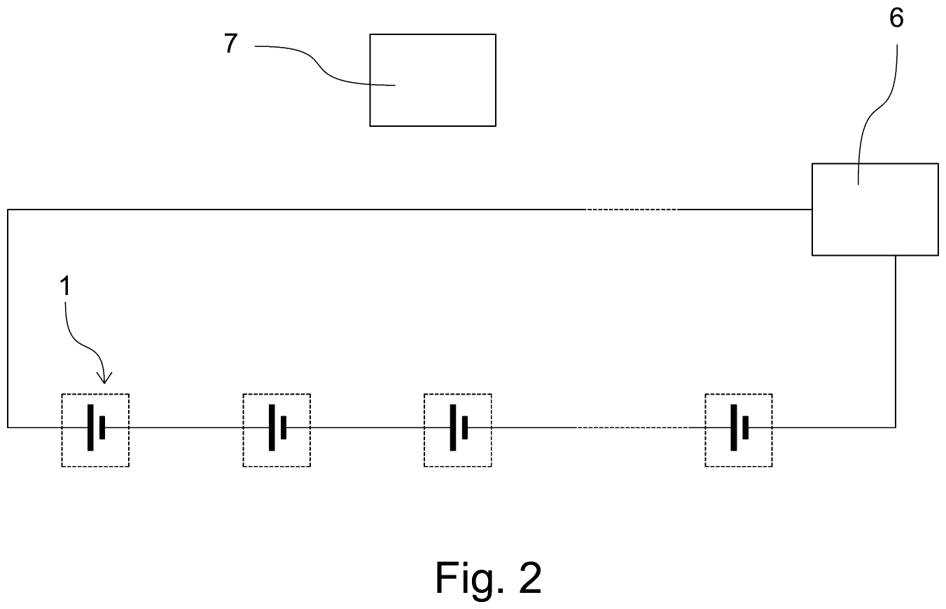

FIG. 2 a battery system;

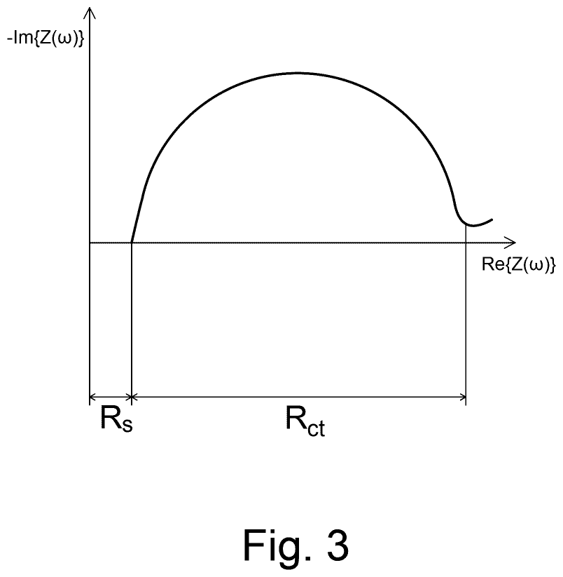

FIG. 3 a Nyquist diagram;

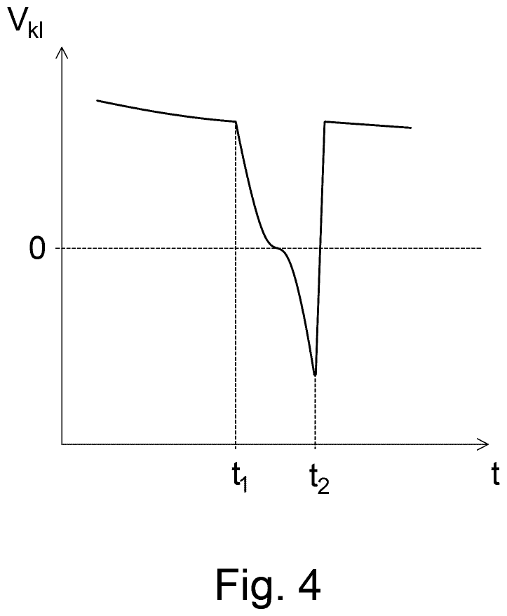

FIG. 4 a time chart of the terminal voltage during the method according to the invention in a first embodiment; and

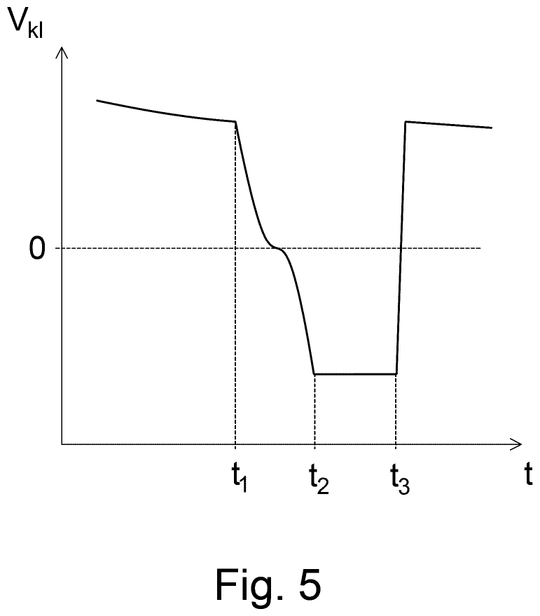

FIG. 5 a time chart of the terminal voltage during the method according to the invention in a second embodiment.

FIG. 1 shows on the left side a schematic representation of a vanadium-based battery module. The battery module is designated with 1. The battery module comprises a cell assembly, designated with 2, a tank device, designated with 3, two pumps, one of which is designated with 4, and optionally a measuring device for detecting the terminal voltage, designated with 5. The cell assembly 2 is an arrangement of a plurality of redox flow cells, which can be arranged arbitrarily. For example, it could be a single cell stack, a series connection of several stacks, a parallel connection of several stacks or a combination of series and parallel connection of several stacks. The tank device 3 is used to store the electrolyte and to supply the cell assembly 2 with electrolyte. To this end, with a few exceptions, the tank device 3 comprises at least two tanks and a pipe system for connecting the tanks to the cell assembly 2. The pumps 4 serve to convey the electrolyte. FIG. 1 shows two separate pumps 4. Equally, the electrolyte could be conveyed with a double-head pump, i.e. with two pumps driven by a common motor. In principle, there can also be more than one pump per electrolyte circuit. This can be advantageous, for example, if the battery module is to have a redundant structure. This means that if one pump fails, the battery module remains functional.

On the right side of FIG. 1, a symbolic representation of battery module 1 is shown. The symbolic representation is used in the following.

FIG. 2 shows a schematic representation of a battery system comprising a plurality of battery modules connected in series. The battery system includes at least two battery modules, one of which is designated with 1, a bidirectional power conversion system (PCS), designated with 6, and a control device, designated with 7. The battery modules 1 are connected in series and connected to the power conversion system 6. FIG. 2 shows four battery modules, wherein the dashed lines in the series connection are to indicate any number of further modules. The power conversion system 6 is used to connect the battery system to the grid or to a higher-level electrical system. Here, the control device 7 is configured to be able to detect the operating state of the power conversion system 6 and to drive the pumps 4 in the battery modules 1. Optionally, the control device 7 can be configured to be able to additionally detect the measured values of the measuring devices 5 of the battery modules 1.

For the following explanations, it is assumed that one or more degraded battery modules 1 have been identified that suffer from the deterioration in efficiency described at the beginning. A person skilled in the art is aware of several possibilities for doing this. For example, the terminal voltage of the battery modules 1 and the charge or discharge current can be detected during operation of the battery system, so that the resistance of the battery modules 1 can be calculated from these values. Degraded battery modules 1 exhibit an increased resistance. Alternatively, the battery modules 1 can be monitored by use of impedance spectroscopy (EIS—“Electrochemical Impedance Spectroscopy”). In this case the impedance Z of the battery modules is determined as a function of the angular frequency ω=2πf. It is advantageous to display Z(ω) in the form of a so-called Nyquist diagram. The real part of Z(ω) is plotted in the x-direction and the negative imaginary part of Z(ω) is plotted in the y-direction. The unit of Z(ω) is ohms. FIG. 3 shows a typical Nyquist diagram of a redox flow battery in qualitative form. Two resistance values can be derived from the diagram: Rₛ and R_{ct}. Rₛ is interpreted as the static internal resistance, which is given, for example, by the resistance of the contacts and the feed lines, while R_{ct} describes the portion resulting from the kinetics of the charge transfer between electrode and electrolyte. Degraded battery modules 1 exhibit an increased value of R_{ct}. A simplified impedance spectroscopy can be used, too, in which only low-frequency excitation signals are used. The simplified method can then be used to determine the sum Rₛ+R_{ct}, which is also increased in the case of degraded battery modules. Another possibility for identifying degraded battery modules 1 is to monitor the state of charge (SoC) of the battery modules. Degraded battery modules charge more slowly and discharge more quickly than non-degraded or less degraded battery modules. For the implementation of the method according to the invention, it is irrelevant which method is used to identify degraded battery modules.

In the following, the method according to the invention is described. For this purpose, a sign convention is used according to which the terminal voltage of the battery modules has the positive sign during normal operation of the battery system.

The method according to the invention for restoring the performance of at least one degraded battery module 1 in a battery system comprises the following steps in the indicated order:
identifying at least one degraded battery module 1;
switching off the pumps 4 of the at least one degraded battery module 1 at a time t₁;
switching on the pumps 4 of the at least one degraded battery module 1 at a (later) time t₂;
   wherein the length of the time interval Δt=t₂−t₁ is selected such that at time t₂ the terminal voltage of the degraded battery module 1 is negative, but overcharging of the electrolyte present in the cell assembly of the degraded battery module 1 is avoided, and wherein these steps, with the exception of the first step, takes place while the battery system is being discharged.

The first step, i.e. identifying at least one degraded battery module, can be carried out during any operating state of the battery system, i.e. both while the battery system is charged and while the battery system is discharged. The other steps, on the other hand, can only be carried out when the battery system is discharged. The identifying step is a step in which it is checked whether the subsequent steps of the method according to the invention should be carried out on a battery module. That is, the method according to the invention in the narrower sense consists of the steps mentioned after the identifying step. In some of the following explanations, the term “method according to the invention” is used in this narrower sense. This is the case when it is clear from the context that one or more battery modules have already been identified.

The electrochemical processes that take place in the degraded battery module in question during the implementation of the method according to the invention are explained in more detail with reference to FIG. 4.

FIG. 4 shows the time chart of the terminal voltage of a degraded battery module during implementation of the method according to the invention. Prior to time t₁, the degraded battery module participates in the discharge process of the battery system like any other battery module of the battery system. In this case, the terminal voltage drops over time because the electrolyte pumped through the cell assembly by the pumps is partially discharged while flowing in the cell assembly. When the pumps are switched off at time t₁, the supply of electrolytes to the cell assembly stops and the electrolyte that is permanently in the cell assembly during this state is therefore discharged much faster, since the discharge current flowing through the battery modules connected in series is not changed or changes only negligibly by the process. The terminal voltage of the degraded battery module drops accordingly quickly. When the terminal voltage reaches the zero line, the electrolyte present in the cell assembly is charged in the opposite direction and the terminal voltage of the battery module in question therefore becomes negative. This is an electrochemical specific of the vanadium electrolyte. From this zero crossing, the processes that led to the formation of the harmful oxygen-containing functional groups begin to reverse, resulting in an at least partial restoration of the performance of the degraded battery module. However, the charging process with the opposite sign cannot be continued for an arbitrarily time, since otherwise the electrolyte present in the cell assembly would become overcharged, which would result in a damage of the battery module. Therefore, the pumps are switched on again at a corresponding selected time t₂. Now fresh electrolyte flows again into the cell assembly. This electrolyte has a charge state as it was shortly before time t₁, so that the terminal voltage rises again to the (positive) value corresponding to t₁. In the time charts shown in FIG. 4, the pumps are operated at the same delivery rate as before time t₁. However, this is not a necessary condition. Rather, it is only intended to express that the battery module in question returns to normal operation at time t₂. If, for some reason, the normal operation of the battery module should require a different pump rate at time t₂ than it had shortly before time t₁, the pumps would be operated at time t₂ at the pump rate required at that time.

The effect of step “switching off the pumps 4 of the at least one degraded battery module 1 at a time t₁” is to cause the described polarity reversal. In principle, this can also be achieved by operating the pumps 4 at a very low delivery rate. Therefore, in the present document, “switching off the pumps” is understood to mean an operation of the pumps that leads to the described polarity reversal.

The time t₂ can be determined most easily by detecting the terminal voltage by means of the control device: if the terminal voltage is sufficiently negative but has not yet fallen below the critical limit, then the pumps are switched on again. However, the time t₂ can also be determined without detecting the terminal voltage. This can be done by a calculation in which at least the following variables are taken into account: state of charge at time t₁, magnitude of discharge current and volume of electrolyte in one cell of the cell assembly of the battery module in question. If the terminal voltage is to be used to determine t₂, then it must be possible to detect voltages with negative signs.

While the pumps are switched off, the discharge current flowing through the battery system can also be reduced. This allows the time point t₂ to be postponed. That is, in this case the time interval Δt=t₂−t₁ becomes larger.

If necessary, the method according to the invention can be carried out several times in succession until the performance of the degraded battery module has been restored to a sufficient degree. In repeating, the first step does not necessarily have to be carried out. However, it can be advantageously carried out to check whether the battery module in question still exhibits any degradation. If there is no or insufficient improvement even after the method according to the invention has been carried out several times, the degradation is at least partially based on non-reversible processes and other maintenance measures can be initiated for the battery module in question.

The inventors have found that the desired effect can be increased by extending the time span during which the terminal voltage remains in the negative range. This can advantageously be achieved by operating the pumps, that are switched on at time t₂, subsequently at a reduced pump rate. The term “reduced” refers to the pump rate that was present before time t₁. FIG. 5 shows the terminal voltage curve corresponding to this embodiment. In the time interval between t₂ and t₃, the pumps are operated at such a pump rate that the terminal voltage remains negative. In the case shown in FIG. 5, the pump rate was selected such that the terminal voltage remains constant in the time interval between t₂ and t₃. Although this is advantageous, it is not absolutely necessary. The positive effect would be almost as pronounced if the pump rate were slightly different. It is only necessary to avoid overcharging of the electrolyte present in the cell assembly during the entire time interval between t₂ and t₃. To this end, the pump rate does not necessarily have to be constant during the time interval mentioned. For example, it could happen that the terminal voltage continues to decrease despite a reduced pump rate and would exceed the critical limit. This can then be avoided by a further reduction of the pump rate. That is, the pump rate can be controlled by the control device in the time interval mentioned so that overcharging is avoided. Δt time t₃, the pumps are then operated again at the pump rate of t₁ so that the battery module returns to the corresponding (positive) terminal voltage. However, this is not a necessary condition. Rather, it is only meant to express that the battery module in question will return to normal operation at time t₃. If, for some reason, the normal operation of the battery module at time t₃ should require a different pump rate than it had shortly before time t₁, the pumps would be operated at time t₃ at the pump rate required at that time.

In the time interval between t₂ and t₃ the discharge current flowing through the battery system can also be reduced. This means that the pump rate in this time interval has to or can be reduced less strongly.

It is to be mentioned that when the pumps are switched on at time t₂ inhomogeneities form in the cell arrangement of the battery module in question. These arise from the fact that fresh electrolyte with a different composition from the rest of the electrolyte present in the cell arrangement is supplied to a specific point in the cell arrangement. This leads to locally different potential states, causing corresponding equalizing currents to form.

The method according to the invention, as shown in FIG. 5, for restoring the performance of at least one degraded battery module 1 in a battery system comprises the following steps in the indicated order:
identifying at least one degraded battery module 1;
switching off the pumps 4 of the at least one degraded battery module 1 at a time t₁;
switching on the pumps 4 of the at least one degraded battery module 1 at a (later) time t₂ and operating the pumps 4 of the at least one battery module 1 at a first pump rate;
operating the pumps 4 of the at least one degraded battery module 1 at a time t₃ after t₂ at a second pump rate;
   wherein the length of the time interval Δt=t₂−t₁ is selected such that at time t₂ the terminal voltage of the at least one degraded battery module 1 is negative, and wherein the first pump rate is selected such that the terminal voltage of the at least one battery module 1 is negative during the time interval between t₂ and t₃, but overcharging of the electrolyte present in the cell assembly of the at least one degraded battery module 1 in the time interval between t₂ and t₃ is avoided, and wherein the second pump rate is selected such that the terminal voltage of the at least one degraded battery module 1 becomes positive after t₃, and wherein these steps, with the exception of the first step, take place while the battery system is being discharged.

The method according to the invention as shown in FIG. 5, too, can be carried out several times in succession if necessary. In this case, the same applies as stated above for the method according to FIG. 4.

Since the battery modules are connected in series in the battery system, the terminal voltages of the battery modules add up. This means that the voltage curve shown in FIGS. 4 and 5 is also reflected in the total voltage present at the power conversion system when the method according to the invention is carried out. Therefore, the power conversion system must be configured in such a way that it can cope with this voltage variability. The same applies to the power of the battery system. If the power output from the battery system is to remain constant, this can be achieved by increasing the discharge current accordingly in the time intervals between t₁ and t₂ and t₁ and t₃, respectively.

In order to ensure that the battery system can continue to function properly while the method according to the invention is being carried out, the total voltage applied to the power conversion system must not become negative. This limits the number of battery modules on which the method according to the invention can be carried out simultaneously. In the limiting case, the number of normally operated battery modules must be greater than the number of battery modules on which the method according to the invention is carried out at a given time. In practice, it will be advantageous if the number of normally operated battery modules is significantly greater than the number of battery modules on which the method according to the invention is carried out at a given time.

To minimize the demands on the power conversion system, it is advantageous if the method according to the invention is only carried out on one battery module at a given time. That is, if more than one battery module are degraded, then the method according to the invention is carried out successively on only one affected battery module at a time.

The method according to the invention can also be advantageously carried out prophylactically. That is, the method is carried out from time to time on each battery module of the battery system. In this case, of course, it is not necessary to first determine whether the battery modules are actually suffering from a significant degree of degradation. It is simply assumed that each battery module degrades to some extent after a certain period of time. The step “identifying at least one degraded battery module 1” then consists merely in determining at least one battery module on which the method according to the invention is to be carried out. This can be done, for example, by first determining an operating time after which a prophylactic execution of the method according to the invention is to be carried out on a battery module. Said identifying step then consists in that for the battery modules of the battery system it is checked whether there are any battery modules that have been operated for longer than the predetermined operating time since the start of operation or the last time the method according to the invention has been carried out. If this is the case, then the steps of the method according to the invention that follow the identifying step are carried out on the battery modules identified in this way.

By use of the method according to the invention, the performance of degraded battery modules can be at least partially restored. The method can be carried out during normal operation of the battery system. No additional hardware is required for carrying out the method, rather the means that are present in ordinary battery modules are sufficient. Only the control device must be configured in such a way that it can execute the method steps according to the invention. For this purpose, a corresponding computer program is run in the control device, which can also be stored on a computer-readable medium.

### LIST OF REFERENCE SYMBOLS

1 Battery module
2 Cell assembly
3 Tank device
4 Pump
5 Measuring device for detecting the terminal voltage
6 Power conversion system
7 Control device

1. A method for restoring performance of a vanadium redox flow battery module in a battery system,
wherein the battery system comprises:
at least two battery modules connected in series,
a power conversion system; and
a control device,
wherein the at least two battery modules are connected to the power conversion system, and wherein each battery module comprises:
a cell device;
a tank device for storing an electrolyte; and
two pumps for conveying the electrolyte through the cell device,
wherein the control device is configured to detect an operating state of the power conversion system and to drive the two pumps in the at least two battery modules,
wherein the method comprises the following steps in the indicated order:
identifying at least one degraded battery module from the at least two battery modules;
switching off pumps of the at least one degraded battery module at a time t₁; and
switching on the pumps of the at least one degraded battery module at a time t₂,
wherein a length of a time interval Δt=t₂−t₁ is selected such that, at time t₂, a terminal voltage of the at least one degraded battery module is negative, but overcharging of the electrolyte present in the cell device of the at least one degraded battery module is avoided, and
wherein switching off the pumps and switching on the pumps are carried out while the battery system is being discharged.

2. The method according to claim 1, wherein, after switching off the pumps of the at least one degraded battery module at a time t₁, the method further comprises the following steps in the indicated order:
switching on the pumps of the at least one degraded battery module at time t₂ and operating the pumps of the at least one degraded battery module at a first pump rate; and
operating the pumps of the at least one degraded battery module at a time t₃ after t₂ at a second pump rate,
wherein the length of the time interval Δt=t₂−t₁ is selected such that at time t₂ a terminal voltage of the at least one degraded battery module is negative,
wherein the first pump rate is selected such that the terminal voltage of the at least one degraded battery module is negative during a time interval between t₂ and t₃, but overcharging of the electrolyte present in the cell device of the at least one degraded battery module in the time interval between t₂ and t₃ is avoided,
wherein the second pump rate is selected such that the terminal voltage of the at least one degraded battery module becomes positive after t₃, and
wherein these steps are carried out while the battery system is being discharged.

3. The battery system of claim 1, wherein the at least two battery modules comprise at least two vanadium redox flow battery modules, and wherein the control device is further configured to carry out the method of claim 1.

4. The battery system according to claim 3, wherein the control device is further configured to detect a terminal voltage of the at least two battery modules.

5. A computer program comprising instructions that cause the battery system of claim 1 to carry out the method according to claim 1.

6. A computer-readable medium on which the computer program according to claim 5 is stored.

7. The battery system of claim 2, wherein the at least two battery modules comprise at least two vanadium redox flow battery modules, and wherein the control device is further configured to carry out the method of claim 2.

8. The battery system according to claim 7, wherein the control device is further configured to detect a terminal voltage of the at least two battery modules.

9. A computer program comprising instructions that cause the battery system of claim 2 to carry out the method according to claim 2.

10. A computer-readable medium on which the computer program according to claim 9 is stored.
